(19) United States
(12) Patent Application Publication
(10) Pub. No.: US 2024/0196473 A1
(43) Pub. Date: Jun. 13, 2024

(54) METHODS FOR HANDLING SIDELINK COMMUNICATION BETWEEN A PLURALITY OF WIRELESS DEVICES, RELATED WIRELESS DEVICES AND A RELATED NETWORK NODE

(71) Applicant: Sony Group Corporation, Tokyo (JP)

(72) Inventors: Torgny PALENIUS, Barsebäck (SE); Anders BERGGREN, Lund (SE)

(21) Appl. No.: 18/287,974

(22) PCT Filed: Apr. 6, 2022
(86) PCT No.: PCT/EP2022/059148

§ 371 Date: Oct. 23, 2023

(30) Foreign Application Priority Data
May 10, 2021 (SE) 2150593-8

(51) Int. Cl. H04W 76/28; H04L 5/00; H04W 88/04

(52) U.S. Cl. CPC H04W 76/28; H04L 5/0048; H04W 88/04

(57) ABSTRACT

A method is disclosed, performed by a first wireless device (WD), for handling sidelink communication with one or more second WDs comprised in a sidelink group with the first WD. The method comprises receiving, from a wireless node, information indicative of a reference Discontinuous Reception (DRX) cycle determined by a network node, wherein 5 the reference DRX cycle enables WDs residing in the communication area for sidelink communication to align their DRX cycles. The method comprises obtaining a sidelink DRX cycle which is aligned with the reference DRX cycle. The method comprises communicating, with the one or more second WDs, in DRX occasions of the obtained sidelink DRX cycle.

The present disclosure pertains to the field of wireless communications. The present disclosure relates to a method for handling sidelink communication, a related wireless device and a related network node.

### BACKGROUND

The 3rd Generation Partnership Project, 3GPP, Release 17, sidelink enhancements are being developed. Sidelink refers to device to device (D2D) communication between a plurality of wireless devices (WDs). Sidelink communication has different modes or casts of communication. These modes or casts are Unicast (between two WDs), Groupcast (between all WDs belonging to a group, such as a sidelink group), and Broadcast (between all WDs connected to a sidelink “cluster”, such as a communication area in which the sidelink configuration is valid).

A WD which is attached to or camping at a cell of a 3GPP radio network node, such as over a Uu interface, may use a first Discontinuous Reception (DRX) configuration in any DRX mode, such as Idle state, Inactive state or Connected mode DRX. The DRX configuration defines a DRX cycle comprising an ON time, such as an ON duration, in which the WD wakes up, such as enters a Radio Resource Control (RRC) Connected state, to listen for messages, and an off time, such as an idle period, in which the WD device may go to sleep, such as enter a power saving mode or a dormant mode. The ON time of the DRX cycle may herein be referred to as a DRX occasion. In a power saving mode, the WD may turn of its transceiver in order to reduce its power consumption. If the WD is simultaneously monitoring or transmitting during a sidelink resource pool, such as a receive resource pool (RxPool) and/or a transmit resource pool (TxPool) (as defined in in TS38.331 v16.4.1) designated for the DRX activities over sidelink using a second DRX configuration, the WD may be required to wake up at a plurality of DRX occasions to listen for messages, which reduces the amount of time when the WD may sleep, which increases the power consumption of the WD. The sidelink resource pool may herein be seen as a pool of resources to be used for sidelink communication. The sidelink resource pool may comprise a pool of transmit (Tx) resources and/or a pool of receive (Rx) resources that may be used for the sidelink transmission.

Furthermore, the WD may simultaneously be involved in both Unicast, Groupcast and Broadcast over the sidelink, where each cast may use a different DRX configuration. This may lead to a further increase in power consumption of the WD. It has been agreed in 3GPP that some sort of alignment of DRX cycles is required in order to overcome this issue.

### SUMMARY

Accordingly, there is a need for devices and methods for handling and/or facilitating sidelink communication, which mitigate, alleviate or address the shortcomings existing and provide a reduced power consumption of the WD.

A method is disclosed, performed by a first wireless device (WD), for handling sidelink communication with one or more second WDs residing in the same communication area for sidelink communication as the first WD. The method comprises receiving, from a wireless node, information indicative of a reference Discontinuous Reception (DRX) cycle determined by a network node. The reference DRX cycle enables WDs residing in the communication area for sidelink communication to align their DRX cycles. The method comprises obtaining a sidelink DRX cycle which is aligned with the reference DRX cycle. The method comprises communicating, with the one or more second WDs, in occasions of the obtained sidelink DRX cycle.

Further, a wireless device is disclosed, the wireless device comprising memory circuitry, processor circuitry, and a wireless interface, wherein the wireless device is configured to perform any of the methods disclosed herein.

It is an advantage of the present disclosure that the DRX cycles of the WDs communicating over sidelink can be configured by referring to the reference DRX configuration in order to be aligned, such that the number of times the WD has to wake up to monitor or transmit during DRX occasions, such as paging occasions in downlink (DL) and/or RxPools and TxPools in sidelink (as defined in e.g., 3GPP TS 38.331 v16.4.1.), for the WDs may be reduced. Thereby, the WD may be in a power saving mode and/or a dormant mode for longer periods of time which reduces the power consumption of the WD. By aligning the DRX occasions for DL and sidelink, the WD may monitor all DRX occasions consecutively when waking up.

Further by providing the reference DRX cycle, the sidelink configurations of all DRX procedures is simplified since they can be provided by sending the parameters which are changed in relation to the reference DRX configuration, instead of sending a complete DRX configuration to the WD.

Further, by aligning the DRX cycles for the WD with the reference DRX cycle, the number of resources that can be used for sidelink communication in a sidelink RxPool and/or Tx Pool may increase where the Reference DRX is defined, since the DRX occasions for all or many WDs participating in the sidelink may be configured based on the same reference DRX occasions. This is due to the DRX occasions, such as the RxPools and/or the TxPools for the sidelink, for the WDs being arranged in the vicinity of the reference DRX occasions, thereby freeing up resources for sidelink communication. Thus, this may lead to an increased number of available resources.

Further, a method is disclosed, performed by a network node, for facilitating sidelink communication between one or more wireless devices (WDs) residing in a communication area for sidelink communication. The method comprises determining a reference Discontinuous Reception (DRX) cycle enabling WDs residing in the communication area for sidelink communication to align their DRX cycles. The method comprises broadcasting, to one or more WDs residing in the communication area for sidelink communication, information indicative of the reference DRX cycle.

Further, a network node is disclosed, the network node comprising memory circuitry, processor circuitry, and a wireless interface, wherein the radio network node is configured to perform any of the methods disclosed herein.

It is an advantage of the present disclosure that the network node may determine a reference DRX cycle which enables the WDs residing in the communication area for sidelink communication to align their DRX cycles for different links, such as sidelink and the wireless link for communicating with the network node. By enabling the DRX cycles of the WDs communicating over sidelink to be aligned, the number of DRX occasions, where the WD has to wake up, such as DRX frames in sidelink and/or paging occasions in DL over the interface between network node and WD, for the WDs may be reduced. Thereby, the WDs may be in a power saving mode and/or a dormant mode for longer periods of time which reduces the power consumption of the WD.

Further, by enabling an alignment of the DRX cycles of the WDs with the reference DRX cycle, the number of resources that can be used for sidelink communication in a frame may increase where the Reference DRX is defined compared with the other DRX occasions, since all or many WDs participating in the sidelink may be configured to use the same reference DRX occasions. This is due to the DRX occasions for the WDs being arranged around the reference DRX occasions, thereby freeing up resources in the frame for sidelink communication. Thus, this may lead to an increased number of available resources.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a diagram illustrating an example of two DRX cycles being aligned according to this disclosure,

FIG. 3 is a diagram illustrating an example alignment of DRX cycles for a plurality of WDs according to this disclosure,

FIG. 4 is a flow-chart illustrating an example method, performed by a first wireless device of a wireless communication system, for handling sidelink communication with one or more second WDs residing in the same communication area for sidelink communication as the first WD according to this disclosure,

FIG. 5 is a flow-chart illustrating an example method, performed by a network node of a wireless communication system, for facilitating sidelink communication between one or more wireless devices, WDs, residing in a communication area for sidelink communication,

FIG. 6 is a block diagram illustrating an example wireless device according to this disclosure,

FIG. 7 is a block diagram illustrating an example network node according to this disclosure,

FIG. 8 is a signaling diagram illustrating an example message exchange between an example network node and a first WD and a second WD for configuring Groupcast sidelink according to this disclosure,

FIG. 9 is a signaling diagram illustrating an example message exchange between an example network node and a first WD and a second WD for configuring Unicast sidelink according to this disclosure, and

FIG. 10 is a signaling signaling diagram illustrating an example message exchange between an example network node and a first WD and a second WD for aligning DRX cycles for an interface between the first WD and/or one or more second WDs and the radio network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

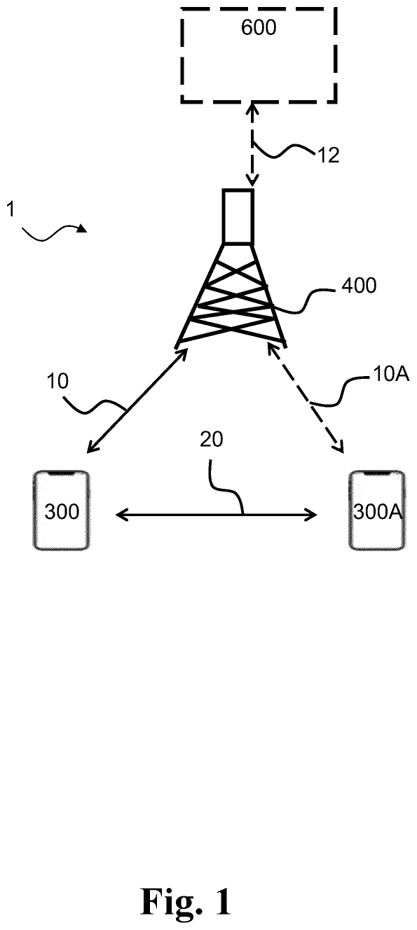

FIG. 1 is a diagram illustrating an example wireless communication system 1 comprising an example network node 400 and an example wireless device 300 according to this disclosure. The wireless communication system 1 optionally comprises an example core network node 600.

As discussed in detail herein, the present disclosure relates to a wireless communication system 1 comprising a cellular system, for example, a 3GPP wireless communication system. The wireless communication system 1 comprises a wireless device 300 and/or a network node 400.

A radio network node disclosed herein refers to a network node operating in the radio access network (RAN), such as a base station, an evolved Node B, eNB, gNB in NR. In one or more examples, the RAN node is a functional unit which may be distributed in several physical units.

A core network, CN, node disclosed herein refers to a network node operating in the core network, such as in the Evolved Packet Core Network, EPC, and/or a 5G Core Network, 5GC. Examples of CN nodes include a Mobility Management Entity (MME) and an Access and Mobility Management Function (AMF). In one or more examples, the CN node is a functional unit which may be distributed in several physical units.

The wireless communication system 1 described herein may comprise one or more wireless devices 300, 300A, and/or one or more radio network nodes 400, such as one or more of: a base station, an eNB, a gNB and/or an access point.

A wireless device may refer to a mobile device and/or a user equipment (UE).

The wireless device 300, 300A may be configured to communicate with the radio network node 400 via a wireless link (or radio access link) 10, 10A, such as a Universal Mobile Telecommunications System air (Uu) interface.

The core network node 600 may be configured to communicate with the radio network node 400 via a link 12, such as a wired and/or wireless link, and/or with the one or more wireless devices 300, 300A, via the radio network node 400.

The wireless devices 300, 300 may be configured to communicate directly with each other via a sidelink 20, such as without communicating via the radio network node 400. The sidelink 20 may be a wireless link.

A wireless node as disclosed herein may refer to a radio network node, such as the radio network node 400, or a WD, such as the WD 300, 300A.

A network node as disclosed herein may refer to a CN node, such as CN node 600, or a radio network node, such as radio network node 400.

The current disclosure relates to methods for aligning DRX occasions of a DRX cycle for different links, such as the wireless link 10 and/or the sidelink 20, for multiple WDs 300, 300A. A DRX cycle is a duration of one ‘ON time’ and one ‘OFF time’ that may be used by a WD to monitor a link, such as a channel, for signals. The ON time defines a time period in which the WD has to wake up to monitor the link for signaling. The OFF time defines a time period in which the WD may be in a power save mode, such as a dormant mode, in which the WD may turn of its radio equipment, such as a transmitter and/or receiver, to save power. The DRX cycle may, for connected mode DRX (C-DRX) over the Uu interface, be calculated based on a subframe time and a parameter referred to as longdrx-CycleStartOffset. A DRX occasion may herein be seen as the ON time of the DRX cycle in which the WD has to wake up to monitor for signals on the link, such as paging signals during Idle-mode DRX (I-DRX) over the Uu interface and/or sidelink transmissions, or to transmit to other WD in the sidelink.

For the interface between the WD and the network node, DRX wakeup times, Paging Occasion (PO) and Paging Frame (PF) may be given by the equations defined in 3GPP TS 38.304 v16.4.0.

The paging occasion related to the DRX wake-up period, may be determined based on the parameter indicative of a wireless device identifier, UE_ID, which may be calculated from a temporary wireless device identifier, such as a Globally Unique Temporary Identifier (GUTI). The GUTI is, due to security reasons, changed every time the WD sends a service request to the core network. Therefore, the PO and/or PF on the Uu interface, moves every time a service request is sent to the Core Network, e.g., due to paging or other communication with the network.

For the sidelink, when two WDs are communicating with Unicast, these WDs may have different DRX cycles, such as DRX POs, on the interface between the WD and the network node. In the current disclosure, these DRX POs may be coordinated with the DRX occasions of the sidelink DRX cycle in both WDs.

A sidelink DRX cycle may be seen as a DRX cycle applied to the sidelink communication. In other words, the sidelink communication may follow the sidelink DRX cycle when sidelink DRX is applied.

In the current disclosure, a reference DRX cycle, such as a reference DRX timing, is introduced within a sidelink (SL) system, to facilitate an alignment of sidelink DRX cycles of different SL casts. A sidelink system may herein be seen as a plurality of WDs residing in, such as being arranged within, a communication area of the sidelink. The communication area may herein be seen as a geographical area and/or a plurality of WDs connected to a sidelink cluster in which the same sidelink configuration and/or reference DRX configuration is valid. A sidelink configuration and/or reference DRX configuration being valid may herein be seen as the sidelink configuration and/or reference DRX configuration being defined and/or being used for the WDs in sidelink communication. A communication area may in one or more examples be a Public Land Mobile Network (PLMN) wide area. A communication area may in one or more examples be a smaller area, such as e.g., an area comprising a plurality of WDs being in sidelink communication distance with a first WD. The WDs residing in the same communication area of the sidelink may be WDs attached to or camping at same and/or different cells of the network and/or may be WDs that are out of coverage of a cell of the network. The WDs residing in the same communication area of the sidelink may be WDs attached to or camping at same and/or different cells of same and/or different PLMNs. The reference DRX cycle may in one or more example methods be used to align a DRX cycle for an interface between the WD and a network node, such as a radio network node, such as a gNB, such as DRX cycle of the WD over the Uu interface. The reference DRX cycle may also be referred to as a Master DRX cycle.

For SL Unicast, the SL DRX cycle for the unicast link may, in one or more example methods, be determined by the WD that is transmitting on the unicast link. For example, if a first WD, such as WD 300 in FIG. 1, is transmitting and a second WD, such as WD 300A in FIG. 1, is receiving, the first WD decides a first SL DRX cycle, such as the DRX occasions used for sidelink communication, based for example on its DRX timing on the interface between the first WD and the network node, such as a radio network node, such as a gNB, on the Uu interface. The first SL DRX cycle may, in one or more example methods, be based on assistance information from the second WD. When the second WD replies, it may, in one or more example methods, be able to determine a second SL DRX cycle. The second SL DRX cycle may be equal to or different from the first SL DRX cycle.

For SL Groupcast, the sidelink DRX cycle may be a common SL DRX cycle when a first WD transmits with one or more second WDs comprised in a sidelink group as receiver. The SL DRX cycle may affect a plurality of WDs simultaneously and each of them, when being in DRX state on the interface between the WD and the network node, may have its own WD specific DRX cycle for the interface between the WD and the network node.

SL Multicast, which may also be referred to as SL broadcast may be similar to SL Groupcast, however instead of the SL DRX cycle affecting just the WDs that are comprised in the SL group, it will affect all WDs that have sidelink activated and/or are configured to participate in SL Multicast.

Hence, each WD participating in SL communication may monitor a plurality of different DRX cycles and may thus have to wake up, such as enter connected mode, in order to monitor the DRX occasions for each of the plurality of DRX cycles. Thus, the time during which the WD is a power saving mode and/or dormant mode may be reduced, which may lead to an increased power consumption of the WD.

The connected mode may be referred to an operation mode wherein a data transmission can be communicated e.g., between the wireless device and a network node or between the wireless device and another wireless device. A connected mode may be referred to an operation state wherein a radio transmitter and/or a radio receiver is activated for such communication. A connected mode may be referred to an operation state wherein the wireless device is synchronized time-wise and/or frequency-wise e.g., by a determined timing advance parameter for the communication. In certain communication systems, a connected mode may be referred to a radio resource control (RRC) state. In various examples, an active state may be a RRC connected state and/or an RRC active state. However, a connected mode may be an active period within another RRC state.

The power saving mode may be a mode where the wireless device is capable of entering various degrees of sleep by disactivating one or more circuitries of the wireless device. The power saving mode may comprise a dormant mode.

The dormant mode is a mode where the UE has no active connection with the network node. A dormant mode may be seen as an inactive mode of the wireless device. A dormant mode may be seen as a mode where the wireless device is unsynchronized with a timing of a network. In one or many examples the wireless device may in a dormant mode not have a valid timing advance information with respect to the network. A dormant mode may be seen as a mode where the wireless device is unable to receive dedicated signaling. A dormant mode may be seen as a mode where closed loop power control is inactivated or suspended. Dormant mode may comprise RRC idle mode, RRC suspend and/or RRC inactive mode. For example, the wireless device may be in dormant mode when the connection with the network node has been released and/or suspended.

The current disclosure provides a solution for aligning the different DRX cycles with each other in order to increase the time the WDs are in a power saving mode and/or dormant mode and thereby reduce power consumption of the WDs.

In order to align a DRX cycle of a WD with the sidelink, all WDs involved in sidelink communication with a first WD should have approximately the same, or close in time, DRX occasions on the interface between the WD and the network node, such as the Uu interface. In an ideal scenario, all WDs would have the exact same DRX timing. But depending on for example the load in the network, the DRX occasions of the DRX cycles may be spread out in time as well. If the number of WDs participating in sidelink communication is large, grouping of the WDs may be done, where subgroups of WDs may be assigned DRX occasions in subsequent RXPools and/or TxPools.

The DRX cycles being aligned herein may be seen as the DRX cycles having DRX occasions arranged at approximately the same time, or close in time, such as in adjacent time resources or within a predetermined duration in time. In other words, the DRX cycles may be aligned when DRX occasions of the DRX cycles coincide and/or are arranged within the predetermined duration in time with each other. For example, the DRX cycles being aligned may be seen as DRX cycles having their respective DRX occasions, such as their ON time, aligned in time. In one or more example methods, the aligned DRX cycles may have coinciding DRX occasions, such as have the exact same DRX timing. However, based on different network conditions, such as a messaging load, the DRX occasions of the aligned DRX cycles may be spread out in time, such as may be arranged in adjacent time resources or slots. If a group of sidelink WDs is very large, the group of sidelink WDs may be divided into subgroups, where the subgroups of WDs may be assigned DRX occasions close in time to each other and to the first WD, such as adjacent to each other. In one or more example methods, different DRX cycles, such as the reference DRX cycle and the sidelink DRX cycle, may have different durations, such that the different DRX cycles may have different frequencies of DRX occasions. For a DRX cycle having a higher frequency of DRX occasions the DRX occasions occur more often than for a DRX cycle having a lower frequency of DRX occasions. In one or more example methods, the length of the DRX cycles may be multiples of each other. Hence, the alignment of the DRX occasions of the DRX cycles does not have to be mutual. Currently, DRX may be configured as 2\hat{ }N frames. Hence, there may always be a factor 1, 2, 4, 8, etc. between the duration of different DRX cycles. For example, if the reference DRX cycle has a length of 0.64 s, the length of the sidelink DRX cycle may be 0.32 s, 0.64 s, 0.128 s, 0.256 s, 0.512 s, and so on, up to a maximum number currently being 10.24 s.

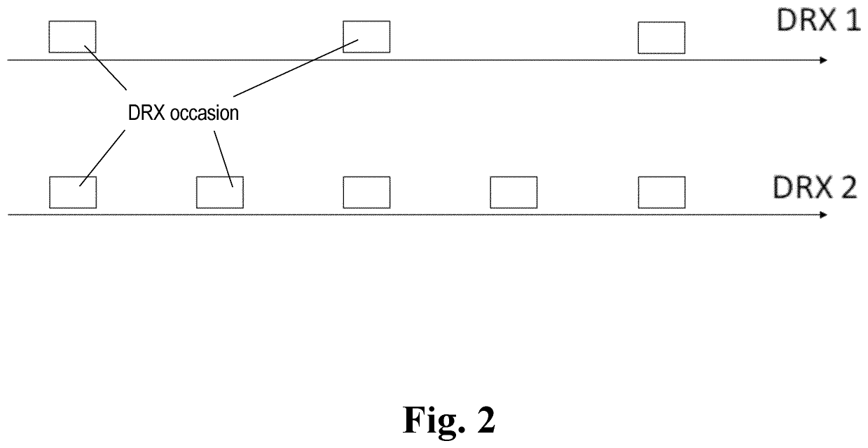

FIG. 2 shows an example of a first DRX cycle and a second DRX cycle, in FIG. 2 referred to as DRX 1 and DRX 2, having aligned DRX occasions. In one or more examples, DRX 1 may correspond to the reference DRX cycle and DRX 2 may correspond to the sidelink DRX cycle. However, it may also be the opposite case, such that DRX 1 may correspond to the sidelink DRX cycle and DRX 2 may correspond to the reference DRX cycle. In other words, the reference DRX cycle may be longer and/or shorter than a sidelink DRX cycle. The example first DRX cycle, DRX 1, and the example second DRX cycle, DRX 2 of FIG. 2 have different lengths, such as different durations. The length of DRX 1 may be a multiple of the length of DRX 2, such as 1280 ms for DRX 1 and 640 ms for DRX 2. Since DRX 1 is longer than DRX 2, DRX 1 has a lower frequency and/or rate of DRX occasions than DRX 2. In this case a DRX occasion for DRX 1 occurs every other DRX occasion for DRX 2. Hence, all of the DRX occasions of DRX 1 may be aligned with a DRX occasion of DRX 2, while only every second DRX occasion of DRX 2 is aligned with a DRX occasions of DRX 1. As can be seen in FIG. 2, only every second DRX occasion of DRX2 is aligned, such as coincides, with a DRX occasion of DRX 1. In other words, not every DRX occasion of a DRX cycle has to coincide with a DRX occasion of a different DRX cycle, for the DRX cycles to be aligned. In one or more example methods, the DRX cycles are aligned when for example every M:th, such as second, third, fourth (and so on), DRX occasion of a DRX cycle is aligned with a DRX occasion of another DRX cycle.

In one or more example methods, the sidelink DRX cycle may be aligned with the reference DRX cycle. Thereafter, each WD may align their respective DRX cycle for the interface between the WD and a radio network node, such as over the Uu interface, based on the reference DRX cycle, but close in time, such as in coinciding and/or adjacent resources and/or slots, to the sidelink DRX occasions of the sidelink DRX cycle.

Different WDs comprised in the same sidelink group and/or may belong to different operators, such as Public Land Mobile Networks (PLMNs). In one or more example methods, the alignment of the DRX cycles may be assisted from the WD to its respective PLMN.

Therefore, according to the current disclosure, within a sidelink system, a reference DRX cycle is introduced. The reference DRX cycle may be used for aligning DRX cycles, such as sidelink DRX cycles and/or DRX cycles for the interface between the WD and the network node, for WDs participating in sidelink communication.

The reference DRX configuration, such as a reference DRX timing and rate, such as a rate of DRX occasions, may be defined by a network, such as by a network node of the network, responsible for the sidelink configuration including a spectrum, such as a frequency spectrum, used for sidelink communication, (herein also referred to as a sidelink spectrum), in the communication area of the sidelink. The communication area may be a geographical area where this sidelink configuration is valid. The reference DRX cycle may be used as a reference for the DRX cycles, such as DRX timings and rates for the WDs belonging to the defined sidelink group, such as WDs comprised in a sidelink group defined by the sidelink spectrum. The sidelink spectrum may be seen as a part of the frequency spectrum that is defined and/or configured to be used for sidelink communication.

In one or more example methods, a network node serving a WD connected to the sidelink may be run by a different operator, such as may be comprised in a different Public Land Mobile Network (PLMN), than the network node that has determined the reference DRX and may not know the reference DRX cycle. In that case, the network node not knowing the reference DRX may ask, such as send a request to, the WDs connected to the sidelink system to assist with the reference DRX cycle.

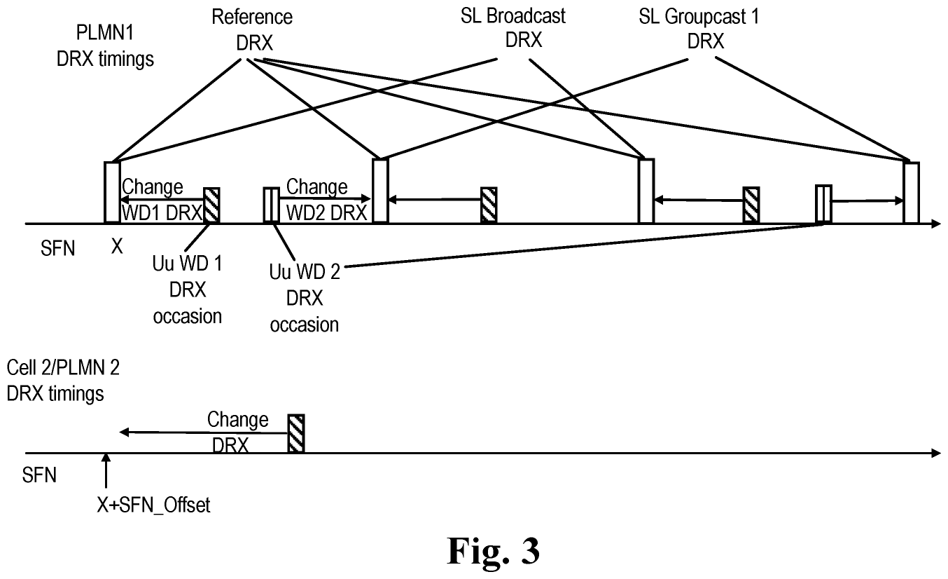

FIG. 3 shows a process of aligning sidelink DRX cycle and a DRX cycle for an interface between one or more WDs, in FIG. 3 referred to as WD1 and WD2, and a network node, such as a Uu interface, with a reference DRX cycle according to one or more examples herein. In FIG. 3 the arrows pointing from the Uu DRX occasions for WD1 and WD2 indicates a change, such as a move, of the Uu DRX occasions for the WDs in order to align the Uu DRX occasions with the sidelink DRX occasions and/or the reference DRX occasions.

For broadcast over sidelink, aimed to reach all WDs within coverage in a sidelink carrier, those WDs may use the reference DRX cycle as sidelink DRX cycle. In other words, the sidelink DRX cycle may have DRX occasions located at the same time as the DRX occasions of the reference DRX cycle. The DRX cycle used for broadcast over sidelink may for example have the same DRX timing as the reference DRX timing of the reference DRX cycle.

For groupcast over sidelink, aimed at reaching a group, such as a subgroup, of WDs within coverage in the sidelink carrier, the DRX cycles for the WDs may use a DRX timing aligned with the reference DRX. The sidelink DRX may for example be aligned in time with the reference DRX cycle but may have a different rate, such as a higher rate and/or a lower rate than the reference DRX. In one or more examples, a DRX rate for the Uu interface may be a multiple of the sidelink DRX rate. If the load, such as with a load of sidelink messages, in a specific DRX occasion, such as in a specific RxPool and/or TxPool, is too high, the groupcast DRX timing can be moved to the next DRX occasion while retaining as long period for deep sleep of the wireless device as possible.

For sidelink Unicast the sidelink DRX cycle may be defined by a first WD, such as a transmitting (Tx) WD with WD assistance, such as UE assistance, from a receiving (Rx) WD. The first WD may be configured to try to align the DRX, such as the DRX cycle, with both the SL DRX, such as the SL DRX cycle, as well as the DRX cycle of the first and the second WDs over the interface for communicating with the network node, such as the Uu interface. By introducing the reference DRX cycle having a reference DRX timing, the first

WD, such as the Tx WD may align the DRX with the reference DRX, which facilitates the agreement of the sidelink DRX cycle between the first WD and the second WD.

Based on the reference DRX, which may be based on a DRX cycle of a first WD, such as a SL group master WD or SL Relay WD, one or more second WDs, such as one or more sidelink receive WDs may provide a WD-offset to the network, such as to the network node, in order to request their respective DRX cycles for the interface between the WD and the network node, such as the Uu interface, to be aligned with the reference DRX cycle and/or the sidelink DRX cycle. The one or more second WDs, such as the sidelink Rx WDs may, from a network point of view, be in Dormant mode, such as in RRC Idle mode. In dormant mode the one or more second WDs may be able to receive legacy downlink paging over the interface between the WD and the network node, but with a paging offset, such as an offset in time of the paging occasion. The network node may determine whether a move of the DRX cycle can be done, for example based on a network condition satisfying an alignment criterion, such as whether a paging load is below a paging load threshold. Upon determining that the network conditions satisfy the alignment criterion, the network node may send an updated DRX configuration to the WD for the interface between the network node and the WD. In the updated DRX configuration, the downlink paging occasions, such as the paging occasions over the interface between the WD and the network node, may be aligned with the sidelink DRX scheme, such as DRX cycle. Thereby, a wake up period for the DRX for the interface between the WD and the network node may correspond to, or be close to, the wake up period for the sidelink DRX cycle. This allows the WD to reduce its power consumption, such as save power, by staying in Dormant mode, such as RRC Idle mode, for longer time durations.

In one or more example methods, if the available resources in the sidelink TxPool defining the time and frequence resources available during one DRX occasion is not enough for the number of sidelink transmissions and a Tx WD aims to transmit the sidelink message later, there may be resources within the TxPool assigned for providing and/or transmitting an indication that the sidelink message is to be sent in a subsequent, such as in the next configured, TxPool.

In one or more example methods, when a WD communicating in the sidelink, such as residing in the communication area of the sidelink, is attached to or camping at a network node run by a different operator, such as being comprised in a different Public Land Mobile Network (PLMN), indicated as Cell 2/PLMN 2 in FIG. 3 than the network node that has determined the reference DRX, the network node of Cell 2/PLMN 2 may not know the reference DRX cycle. In that case, the network node not knowing the reference DRX may ask, such as send a request to, the WDs connected to the sidelink system to assist with the reference DRX cycle. The WD connected to Cell 2/PLMN 2 may send a request to the network node for alignment of its DRX cycle for the interface between the WD and the radio network node, such as the radio network node of Cell 2/PLMN2, with the sidelink DRX cycle and/or the reference DRX cycle. The request may in one or more example methods comprise an offset from the current location of the DRX occasion to the reference DRX occasion. The offset may be indicated based on the SFN timing. Based on the request, the network node of PLMN 2 may send an updated DRX configuration for the interface between the WD and the radio network node for aligning the DRX cycle for the interface between the WD and the radio network node of PLMN 2 with the sidelink DRX cycle and/or the reference DRX cycle.

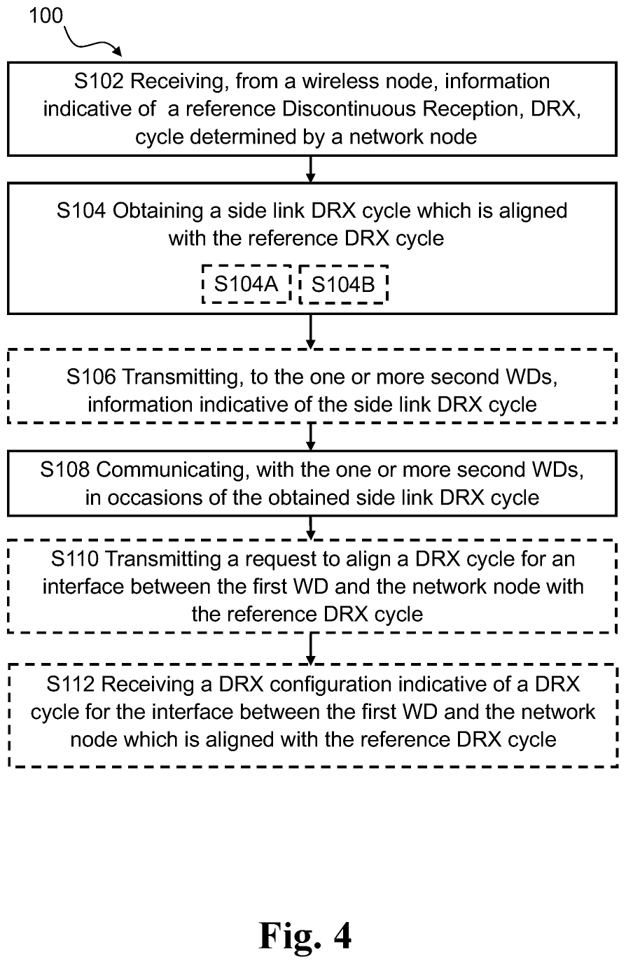

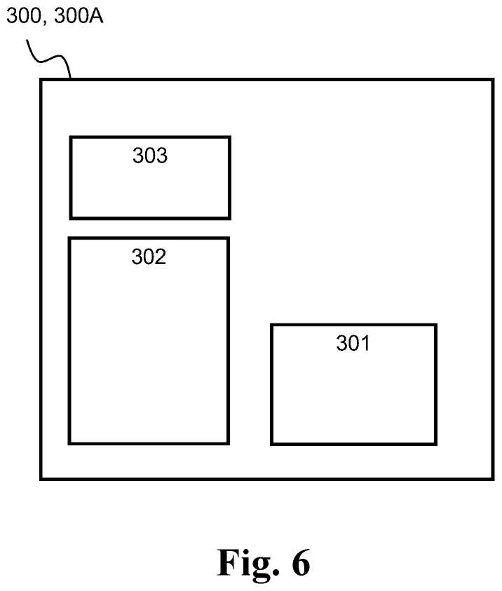

FIG. 4 shows a flow diagram of an example method 100, performed by a first WD according to the disclosure, for handling sidelink communication with one or more second WDs residing in the same communication area for sidelink communication as the first WD. The communication area for sidelink communication may be an area where the sidelink configuration is valid, for example a geographic area where the sidelink configuration is valid. The first WD may be the wireless device disclosed herein, such as wireless device 300 of FIG. 1, and FIG. 6.

The method 100 comprises receiving S102, from a wireless node, information indicative of a reference DRX cycle determined by a network node. The reference DRX cycle is a DRX cycle that wireless devices residing in the communication area for sidelink communication can use as a common reference. The reference DRX cycle enables WDs in the communication area for sidelink communication to align their DRX cycles. The wireless node is in one or more example methods a radio network node, such as a base station or a gNB, and in other example methods another WD communicating in the sidelink. The network node may in one or more examples be radio network node, such as a base station or a gNB, or a core network node, such as an Access and Mobility Management Function (AMF) comprised in the core network. In one or more example methods, the information indicative of the reference DRX cycle comprises one or more of a reference DRX timing, a reference DRX rate, and a time offset of the reference DRX cycle in relation to a timing of a cell, such as for example a Single Frequency Network (SFN) timing of the cell, in which the WDs is camping, or an offset of the reference DRX cycle in relation to a sidelink time reference as described in 3GPP TR 37.985, v16.0.0. The information indicative of the reference DRX cycle determined by the network node may be received via Radio Resource Control (RRC) signaling. In one or more example methods, the information indicative of the reference DRX cycle may be comprised in a sidelink configuration message. The information indicative of the reference DRX cycle may be comprised in sidelink assistance information. The information indicative of the reference DRX cycle may be received over the Uu interface. The reference DRX cycle may be geographically limited, such as to a communication area of the sidelink communication.

The method 100 comprises obtaining S104 a sidelink DRX cycle which is aligned with the reference DRX cycle. The DRX cycles being aligned herein may be seen as the DRX cycles having DRX occasions arranged at approximately the same time, or close in time, such as in adjacent time resources or within a predetermined duration in time. In other words, the DRX cycles may be aligned when DRX occasions of the DRX cycles coincide and/or are arranged within the predetermined duration in time with each other. For example, the DRX cycles being aligned may be seen as DRX cycles having their respective DRX occasions, such as their ON time, aligned in time. In one or more example methods, the aligned DRX cycles may have coinciding DRX occasions, such as have the exact same DRX timing. However, based on different network conditions, such as a messaging load, the DRX occasions of the aligned DRX cycles may be spread out in time, such as may be arranged in adjacent time resources and/or slots. If a group of sidelink WDs is very large, the group of sidelink WDs may be divided into subgroups, where the subgroups of WDs may be assigned DRX occasions close in time to each other and to the first WD, such as adjacent to each other. In this case the DRX may require a longer, such as an extended, period to support all data. In one or more example methods, different DRX cycles, such as the reference DRX cycle and the sidelink DRX cycle, may have different durations, such that the different DRX cycles may have different frequencies of DRX occasions. For a DRX cycle having a higher frequency of DRX occasions the DRX occasions occur more often than for a DRX cycle having a lower frequency of DRX occasions. In one or more example methods, the length of the DRX cycles may be multiples of each other. Hence, the alignment of the DRX occasions of the DRX cycles does not have to be mutual. Currently, DRX may be configured as 2\hat{ }N frames. Hence, there may always be a factor 1, 2, 4, 8, etc. between the duration of different DRX cycles.

The method 100 comprises communicating S108 with the one or more second WDs, in occasions of the obtained sidelink DRX cycle. In other words, the first WD may apply the obtained sidelink DRX cycle to sidelink communication, such as transmitting and/or receiving sidelink messages, with the one or more second WDs. Communicating in occasion of the obtained sidelink DRX cycle may herein be seen as the WDs communicating in sidelink exiting power save mode, such as dormant mode at DRX occasions aligned with the reference DRX cycle and may thus monitor DRX occasions for different links, such as sidelink and/or the interface between the WD and the radio network node in aligned, such as coinciding and/or consecutive, DRX occasions. Thereby, the OFF period of the WDs, such as the time period in which the WD may enter power save mode and/or dormant mode may be increased, which reduces the power consumption of the WD.

In one or more example methods, obtaining S104 the sidelink DRX cycle comprises receiving S104A information indicative of the sidelink DRX cycle from the wireless node, such as from the radio network node. In one or more example methods, the network node may determine the sidelink DRX cycle which is aligned with the reference DRX cycle. The first WD may receive the information indicative of the sidelink DRX cycle determined by the network node from the wireless node. The information indicative of the sidelink DRX cycle may comprise one or more of a sidelink DRX timing, a sidelink DRX rate, and a time offset of the sidelink DRX cycle in relation to a timing of the reference DRX cycle. In one or more example methods, the WD may receive the information indicative of the sidelink DRX cycle from the wireless node when the WD is communicating over the sidelink via groupcast and/or broadcast.

In one or more example methods, obtaining S104 the sidelink DRX cycle comprises determining S104B the sidelink DRX cycle based on the information indicative of the reference DRX cycle. The first WD may receive the information indicative of the reference DRX cycle from the wireless node and may determine the sidelink DRX cycle based on the reference DRX cycle. In one or more example methods, the sidelink DRX cycle may be determined based on assistance information received from the one or more second WDs. The assistance information may in one or more example methods be indicative of a DRX cycle of the one or more second WDs for an interface between the one or more second WDs and the network node, such as a DRX cycle used for communication with the network node, such as a DRX cycle for the Uu interface.

In one or more example methods, the WD may determine the information indicative of the sidelink DRX cycle when the WD is communicating over the sidelink via unicast.

In one or more example methods, such as when the first WD has determined the sidelink DRX cycle, the method may comprise transmitting S106, to the one or more second WDs, information indicative of the sidelink DRX cycle. The first WD may thus inform the one or more second WDs about the determined sidelink DRX cycle, so that the one or more second WDs can apply the determined sidelink DRX cycle to sidelink communication with the first WD.

In one or more example methods, the method comprises transmitting S110, to the network node, a request to align a DRX cycle for an interface between the first WD and the network node with the sidelink DRX cycle and/or the reference DRX cycle. DRX paging occasions of a DRX cycle for the interface between the WD and the network node, such as over the Uu interface, are normally spread out over time. However, WDs involved in sidelink communication, such as power constrained WDs, e.g., pedestrian WDs or WDs of a user riding a bicycle, may use an opportunity to align the DRX cycle for the interface between the WD and the network node with the reference DRX cycle for all of these WDs.

In one or more example methods, the WDs may request an alignment of the DRX cycle for the interface between the WD and the network node, such as the Uu interface, according to the obtained sidelink DRX cycle. The DRX cycle for the interface between the WD and the network node may in one or more example methods be aligned with the sidelink DRX cycle by moving the DRX occasions the interface between the WD and the network node to a resource and/or a slot close in time to, such as adjacent to, the resource and/or slots for the DRX occasions for the sidelink DRX cycle. Thereby the WD may monitor and potentially reply to a paging message sent to the WD over the interface between the WD and the network node, without getting interrupted from transmissions over the sidelink.

In one or more example methods, the method comprises receiving S112, from the network node, a DRX configuration indicative of a DRX cycle for the interface between the first WD and the network node which is aligned with the reference DRX cycle.

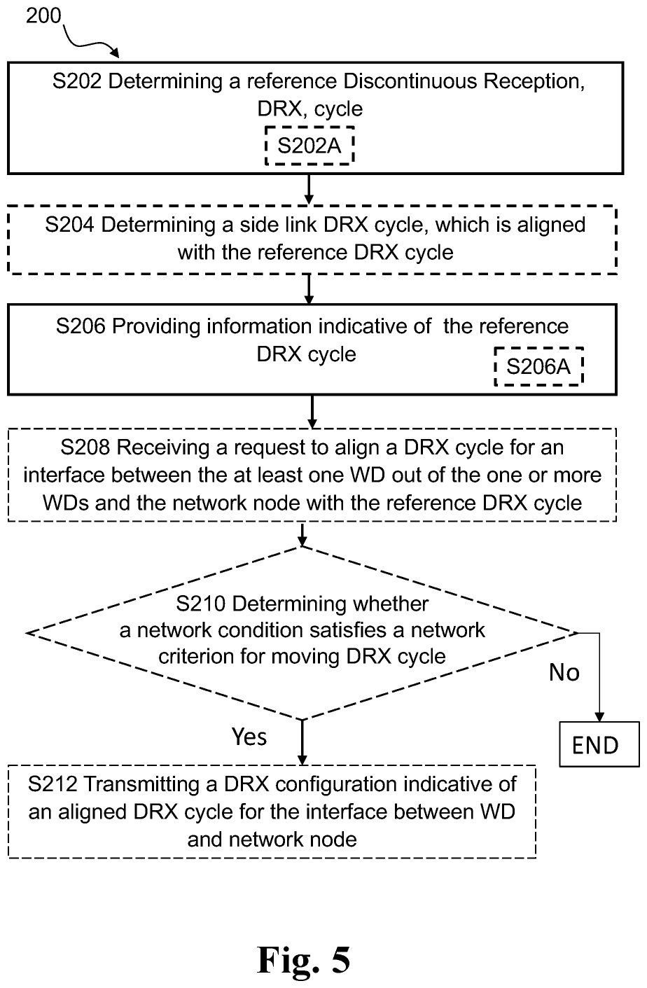

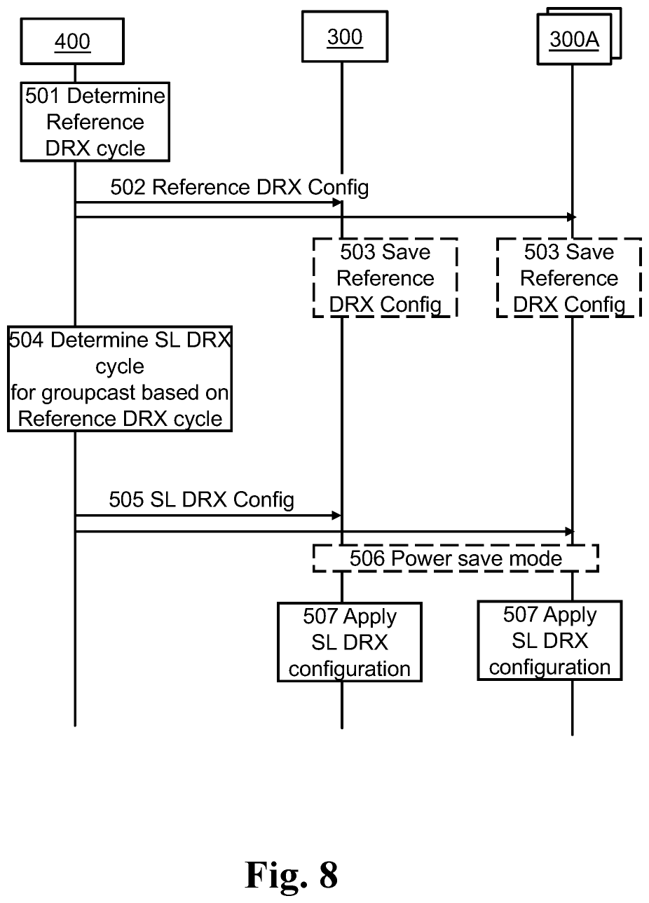

FIG. 5 shows a flow diagram of an example method 200, performed by a network node according to the disclosure, for facilitating sidelink communication between one or more WDs residing in a communication area for sidelink communication. The network node may be the network node disclosed herein, such as radio network node 400 of FIG. 1, and FIG. 8, or core network node 600 of FIG. 1. The network node may be a network node responsible for, such as serving, a sidelink spectrum, such as a communication area and/or a geographical area of the sidelink.

The method 200 comprises determining S202 a reference DRX cycle. The reference DRX cycle may enable WDs residing in the communication area for sidelink communication to align their DRX cycles, such as sidelink DRX cycles and/or DRX cycles for the interface between the WD and the network node, such as for WDs located in a first geographical area. The sidelink DRX cycles and/or DRX cycles for an interface between a WD and a network node may be aligned based on the reference DRX cycle. In one or more example methods, determining S202 the reference DRX cycle comprises determining S202A the reference DRX cycle based on a DRX cycle for an interface between a first WD of the one or more WDs and the network node.

The method 200 comprises providing S206 information indicative of the reference DRX cycle. The information indicative of the reference DRX cycle may be provided to one or more WDs. The information indicative of the reference DRX cycle may be provided to one or more WDs in the communication area for sidelink communication. Providing S206 may in one or more example methods comprise transmitting the information indicative of the reference DRX via dedicated RRC signaling. Providing S206 may in one or more example methods comprise broadcasting the information indicative of the reference DRX. In other words, the information indicative of the reference DRX cycle may be provided via broadcasting and/or dedicated RRC signaling to one or more WDs residing in the communication area. In one or more example methods, the information indicative of the reference DRX cycle comprises one or more of a reference DRX timing, a reference DRX rate and a time offset of the reference DRX cycle in relation to a timing of a cell in which the WD is camping, such as an SFN timing. The information indicative of the reference

DRX cycle may in one or more example methods be a reference DRX configuration. The information indicative of the reference DRX cycle may be comprised in a sidelink configuration message. The information indicative of the reference DRX cycle may be transmitted via RRC signaling. The reference DRX may be transmitted, such as broadcasted, from the network node to all the WDs. In one or more example methods, the information indicative of the reference DRX cycle may comprise information indicative of one or more reference DRX cycles. The one or more reference DRX cycles may have the same timing but different other parameters, such as timers and/or durations.

In one or more example methods, the method comprises determining S204 a sidelink DRX cycle, which sidelink DRX cycle is aligned with the reference DRX cycle. In one or more example methods, the network node, such as the radio network node and/or the core network node, may determine the sidelink DRX to be used for a plurality of WDs communicating in sidelink, such as WDs communicating during groupcast and/or broadcast over the sidelink.

In one or more example methods, transmitting S206 information comprises transmitting S206A information indicative of the determined sidelink DRX cycle. In one or more example methods, the information indicative of the sidelink DRX cycle comprises one or more of a sidelink DRX timing, a sidelink DRX rate and a time offset of the sidelink DRX cycle in relation to a timing of the reference DRX cycle.

In one or more example methods, the method comprises receiving S208, from at least one WD out of the one or more WDs, a request for alignment of a DRX cycle for an interface between the at least one WD out of the one or more WDs and the network node with the reference DRX cycle.

In one or more example methods, the method comprises determining S210 whether a network condition satisfies an alignment criterion for moving the DRX cycle for the interface between the at least one WD out of the one or more WDs and the network node, such as in accordance with the request received from the one or more WDs. An alignment criterion may be seen as a criterion to check whether the network conditions allow for the DRX cycle to be aligned with the reference DRX cycle and/or the sidelink cycle. In one or more example methods, the network condition may be a paging load of the Uu interface in the network and the alignment criterion may be that the paging load is to be below a paging load threshold. When a plurality of WDs communicating in sidelink requests to align their respective Uu DRX with the sidelink DRX, that has been defined based on the reference DRX, the load on a specific paging occasion may be too high. The network node may in one or more example methods, consider each WD request for DRX alignment individually based on network conditions, such as paging load.

In one or more example methods, the method comprises, upon determining that the network condition satisfies the alignment criterion for moving the DRX cycle for the interface between the at least one WD out of the one or more WDs and the network node, transmitting S212, to the at least one WD out of the one or more WDs, a DRX configuration indicative of a DRX cycle for the interface between the at least one WD out of the one or more WDs and the network node which is aligned with the reference DRX cycle and/or the sidelink DRX cycle. When the network node has determined that the network condition satisfies the alignment criterion, the network node may determine an aligned DRX configuration for the WD to be used over the interface between the at least one WD out of the one or more WDs and the network node, the network node may determine a DRX configuration for the at least one WD out of the one or more WDs, for which the DRX cycle has been aligned with the sidelink DRX cycle and/or the reference DRX cycle. The aligned DRX configuration may, in one or more example methods, comprise a temporary UE_ID that may be used by the WD to calculate the DRX occasion, such as paging occasion, and/or the paging frame of the aligned DRX cycle.

FIG. 6 shows a block diagram of an example wireless device, WD, 300, 300A according to the disclosure. The wireless device 300 comprises memory circuitry 301, processor circuitry 302, and a wireless interface 303. The wireless device 300 (e.g., acting as a first wireless device) may be configured to perform any of the methods disclosed in FIG. 4. In other words, the wireless device 300 may be configured for handling side link communication with one or more second WDs residing in the same communication area for sidelink communication as the first WD.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution—enhanced Machine Type Communication, LTE-M.

The wireless device 300 is configured to receive (such as via the wireless interface 303), from a wireless node, information indicative of a reference Discontinuous Reception, DRX, cycle determined by a network node. The reference DRX cycle may enable WDs in the communication area for sidelink communication to align their DRX cycles.

The wireless device 300 is configured to obtain (such as via the wireless interface 303) a side link DRX cycle which is aligned with the reference DRX cycle.

The wireless device 300 is configured to communicate (such as via the wireless interface 303), with the one or more second WDs, in occasions of the obtained side link DRX cycle

The wireless device 300 is optionally configured to perform any of the operations disclosed in FIG. 4 (such as any one or more of S104A, S104B, S106, S110, S112). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 6). Memory circuitry 301 is considered a non-transitory computer readable medium.

Memory circuitry 301 may be configured to store information, such as information indicative of the reference DRX cycle and/or information indicative of the side link DRX cycle in a part of the memory.

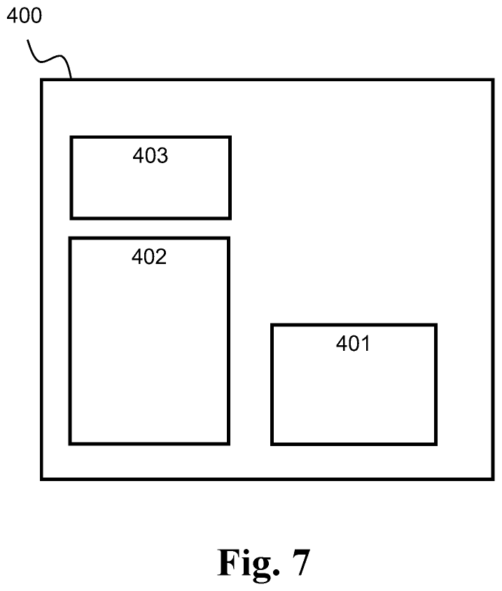

FIG. 7 shows a block diagram of an example network node 400 according to the disclosure. The network node 400 comprises memory circuitry 401, processor circuitry 402, and a wireless interface 403. The network node 400 may be configured to perform any of the methods disclosed in FIG. 5. In other words, the network node 400 may be configured for facilitating side link communication between one or more wireless devices, WDs residing in a communication area for sidelink communication.

The network node 400 is configured to determine (such as by using the processor circuitry 402) a reference Discontinuous Reception, DRX, cycle. The reference DRX cycle may enable WDs residing in the communication area for sidelink communication to align their DRX cycles.

The wireless interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M.

The network node 400 is configured to broadcast (such as using the wireless interface 403) information indicative of the reference DRX cycle. The network node 400 may be configured to broadcast (such as using the wireless interface 403) the information indicative of the reference DRX cycle to one or more WDs residing in the communication area for sidelink communication.

Processor circuitry 402 is optionally configured to perform any of the operations disclosed in FIG. 5 (such as any one or more of S202A, S204, S206A, S208, S210, S112). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 7). Memory circuitry 401 is considered a non-transitory computer readable medium.

Memory circuitry 401 may be configured to store information, such as such as information indicative of the reference DRX cycle, information indicative of the side link DRX cycle in a part of the memory, and/or an alignment criterion in a part of the memory.

FIG. 8 discloses a signaling diagram illustrating an example message exchange between an example radio network node 400, a first WD 300 and a second WD 300A communicating via sidelink during an example operation for configuration of DRX cycles for Groupcast according to this disclosure.

The radio network node 400, such as the radio network node, may determine 501 a reference DRX cycle. The reference DRX cycle enables WDs residing in the communication area for sidelink communication to align their DRX cycles. This corresponds to S202 performed by the network node as described in relation to FIG. 5.

The radio network node 400 may broadcast information 502 indicative of the reference DRX cycle. The information indicative of the reference DRX cycle may be broadcasted to one or more WDs, such as the first WD 300 and one or more second WDs 300A residing in the communication area for sidelink communication. This corresponds to S206 performed by the network node as described in relation to FIG. 5.

In one or more example methods, the first WD 300 and the second WD 300A may store 503 the information indicative of the reference DRX cycle. The information may be stored in memory of the first WD 300 and the one or more second WDs 300A.

The radio network node 400 may determine 504 a sidelink DRX cycle based on the reference DRX cycle, to be used by the first WD 300 and the one or more second WDs 300A during sidelink communication. The sidelink DRX cycle is aligned with the reference DRX cycle, such that the sidelink DRX cycle may have DRX occasions located at the same time as the DRX occasions of the reference DRX cycle or close in time of DRX occasions of the reference DRX cycle. This corresponds to S204 performed by the network node as described in relation to FIG. 5.

The radio network node 400 may transmit, such as broadcast, a sidelink DRX configuration 505 to the first WD 300 and the one or more second WDs 300A. The sidelink DRX configuration may be indicative of a sidelink DRX cycle being aligned with the reference DRX cycle. During the transmission of the sidelink DRX configuration, the first WD 300 and the one or more second WDs 300A may be in connected mode. This corresponds to S206A performed by the network node as described in relation to FIG. 5.

After the first WD 300 and the one or more second WDs 300A have received the sidelink DRX configuration, the first WD 300 and the one or more second WDs 300A may enter 506 a power save mode, such as a dormant mode.

The first WD 300 and the one or more second WDs 300A may apply the sidelink DRX cycle according to the sidelink DRX configuration. The first WD 300 and the one or more second WDs 300A may thus wake up and enter RRC connected mode at the DRX occasions to listen for messages and may thereafter go back to power save mode again. This corresponds to S108 performed by the wireless device as described in relation to FIG. 4.

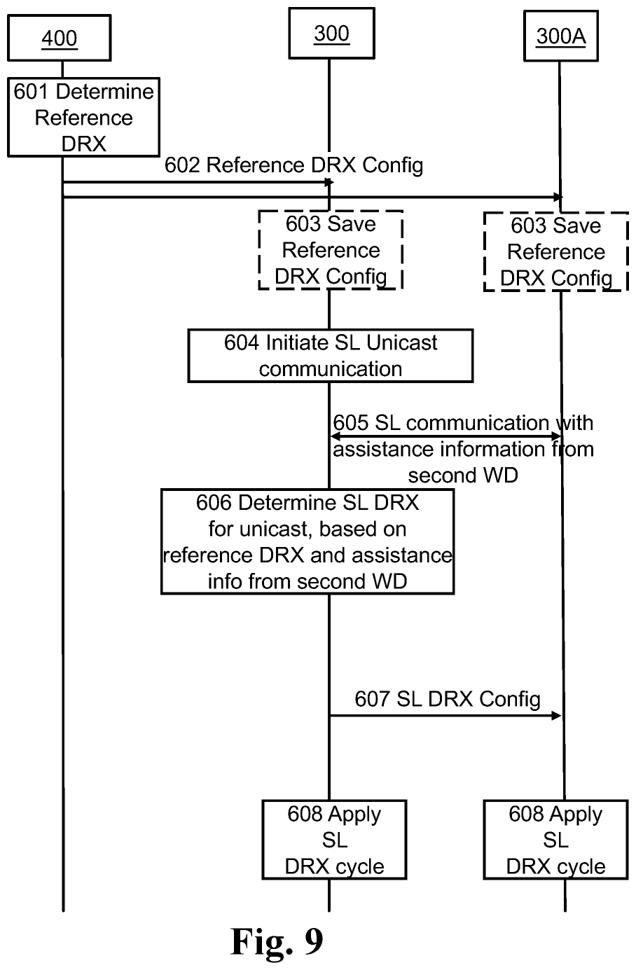

FIG. 9 discloses a signaling diagram illustrating an example message exchange between an example radio network node 400, a first WD 300 and a second WD 300A communicating via sidelink during an example operation for configuration of DRX cycles for Unicast according to this disclosure.

The radio network node 400, such as the radio network node, may determine 601 a reference DRX cycle. The reference DRX cycle enables WDs residing in the communication area for sidelink communication to align their DRX cycles. This corresponds to S202 performed by the network node as described in relation to FIG. 5.

The radio network node 400 may provide, such as broadcast or transmit via dedicated RRC signaling, information 602 indicative of the reference DRX cycle. The information indicative of the reference DRX cycle may be provided to one or more WDs, such as the first WD 300 and one or more second WDs 300A residing in the communication area for sidelink communication. This corresponds to S206 performed by the network node as described in relation to FIGS. 5 and S104A performed by the wireless device as described in relation to FIG. 4.

In one or more example methods, the first WD 300 and the second WD 300A may store 603 the information indicative of the reference DRX cycle. The information may be stored in memory of the first WD 300 and the one or more second WDs 300A.

The first WD 300 may initiate sidelink unicast communication 604 with a second WD 300A.

The first WD 300 and the second WD 300A may communicate over the sidelink. During the sidelink communication, the second WD 300A may provide assistance information 605 to the first WD 300.

The first WD 300 determines a sidelink DRX cycle 606 based on the reference DRX cycle and/or the assistance information from the second WD 300A, to be used by the first WD 300 and the second WD 300A during sidelink communication. The sidelink DRX cycle is aligned with the reference DRX cycle, such that the sidelink DRX cycle may have DRX occasions located at the same time as the DRX occasions of the reference DRX cycle or close in time of DRX occasions of the reference DRX cycle. This corresponds to S104B performed by the wireless device as described in relation to FIG. 4.

The first wireless device 300 may transmit a sidelink DRX configuration 607 to the second WD 300A. The sidelink DRX configuration may be indicative of the determined sidelink DRX cycle. This corresponds to S106 performed by the wireless device as described in relation to FIG. 4.

The first WD 300 and the one or more second WDs 300A may apply the sidelink DRX cycle according to the sidelink DRX configuration. The first WD 300 and the one or more second WDs 300A may thus wake up and enter RRC connected mode at the DRX occasions to listen for messages and may thereafter go back to power save mode again.

This corresponds to S108 performed by the wireless device as described in relation to FIG. 4.

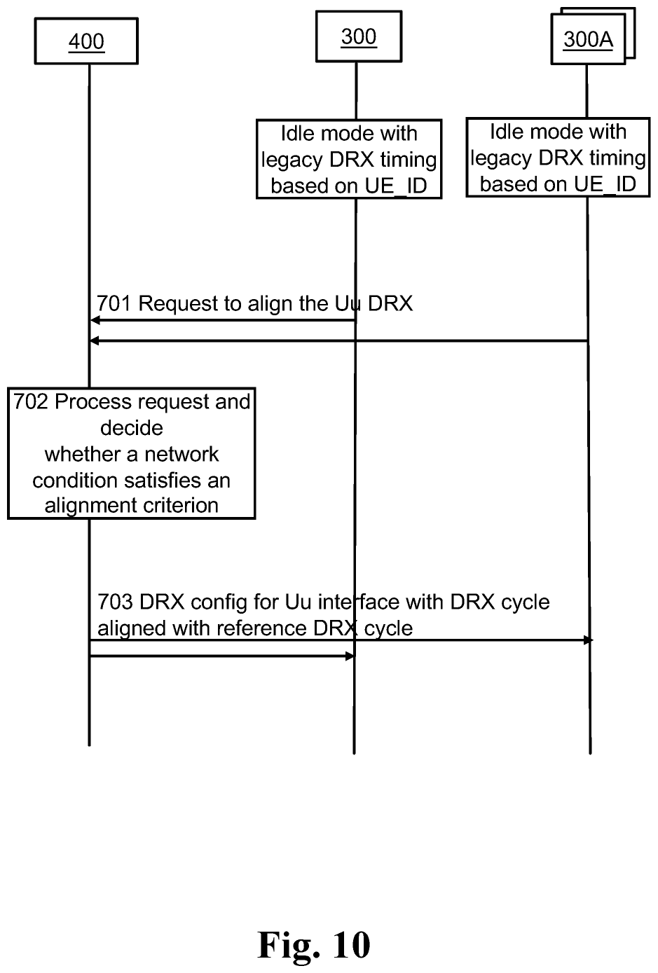

FIG. 10 discloses a signaling diagram illustrating an example message exchange between an example radio network node 400, a first WD 300 and a second WD 300A communicating via sidelink during an example operation for alignment of DRX cycles for an interface between the radio network node 400 and the first WD and/or the one or more second WDs 300A according to this disclosure. The message exchange disclosed in FIG. 9 may take place after either of the message exchanges illustrated in FIG. 8 or FIG. 9. The first WD 300 and/or the one or more second WDs 300A may be in RRC Idle mode with a legacy DRX cycle, such as DRX timing, PO and/or PA being determined based on a WD identifier, such as the parameter UE_ID.

The first WD 300 and/or the one or more second WDs 300A may send a request 701 to the radio network node to align a DRX cycle of the respective WD 300, 300A for an interface between the respective WD 300, 300A and the radio network node 400, such as for an Uu interface, with the sidelink DRX cycle and/or the reference DRX cycle. This corresponds to S110 performed by the wireless device as described in relation to FIG. 4 and to S208 performed by the network node as described in relation to FIG. 5.

The radio network node 400 determines 702 whether a network condition satisfies an alignment criterion for moving, such as aligning, the DRX cycle for the interface between the first WD 300 and/or the one or more second WDs 300A and the network node, such as for the Uu interface. This corresponds to S210 performed by the network node as described in relation to FIG. 5.

Upon determining that the network condition satisfies the alignment criterion, the radio network node 400 may transmit a DRX configuration 703 indicative of a DRX cycle for the interface between the first WD 300 and/or the one or more second WDs 300A and the radio network node 400, such as for the Uu interface, which is aligned with the reference DRX cycle and/or the sidelink DRX cycle. The first WD 300 and/or the one or more second WDs 300A may align the DRX cycles according to the DRX configuration indicative of a DRX cycle for the interface between the first WD 300 and/or the one or more second WDs 300A and the radio network node 400 This corresponds to S112 performed by the wireless device as described in relation to FIG. 4 and to S212 performed by the network node as described in relation to FIG. 5.

Examples of methods and products (wireless device and network node) according to the disclosure are set out in the following items:
Item 1. A method performed by a first wireless device, WD, for handling sidelink communication with one or more second WDs residing in the same communication area for sidelink communication as the first WD, the method comprising:
   receiving (S102), from a wireless node, information indicative of a reference Discontinuous Reception, DRX, cycle determined by a network node, wherein the reference DRX cycle enables WDs residing in the communication area for sidelink communication to align their DRX cycles,
   obtaining (S104) a sidelink DRX cycle which is aligned with the reference DRX cycle, and
   communicating (S108), with the one or more second WDs, in DRX occasions of the obtained sidelink DRX cycle.
Item 2. The method according to Item 1, wherein obtaining (S104) the sidelink DRX cycle comprises receiving (S104A) information indicative of the sidelink DRX cycle from the wireless node.
Item 3. The method according to Item 1, wherein obtaining (S104) the sidelink DRX cycle comprises determining (S104B) the sidelink DRX cycle based on the information indicative of the reference DRX cycle.
Item 4. The method according to Item 3, wherein the sidelink DRX cycle is determined based on assistance information received from the one or more second WDs.
Item 5. The method according to Item 4, wherein the assistance information is indicative of a DRX cycle of the one or more second WDs for an interface between the one or more second WD and the network node.
Item 6. The method according to any one of the previous Items, wherein the method comprises:

transmitting (S106), to the one or more second WDs, information indicative of the sidelink DRX cycle.
Item 7. The method according to any one of the previous Items, wherein the method comprises:

transmitting (S110), to the network node, a request to align a DRX cycle for an interface between the first WD and the network node with the reference DRX cycle.
Item 8. The method according to Item 7, wherein the method comprises:

receiving (S112), from the network node, a DRX configuration indicative of a DRX cycle for the interface between the first WD and the network node which is aligned with the reference DRX cycle.
Item 9. The method according to any of Items 6-8, wherein the information indicative of the sidelink DRX cycle comprises one or more of a sidelink DRX timing, a sidelink DRX rate, and a time offset of the sidelink DRX cycle in relation to a timing of the reference DRX cycle.
Item 10. The method according to any one of the previous Items, wherein the information indicative of the reference DRX cycle comprises one or more of a reference DRX timing, a reference DRX rate, and a time offset of the reference DRX cycle in relation to a timing of a cell in which the WDs is camping.
Item 11. A method performed by a network node for facilitating sidelink communication between one or more wireless devices, WDs, residing in a communication area for sidelink communication, the method comprising:
   determining (S202) a reference Discontinuous Reception, DRX, cycle enabling WDs residing in the communication area for sidelink communication to align their DRX cycles, and
   providing (S206), to one or more WDs residing in the communication area for sidelink communication, information indicative of the reference DRX cycle.
Item 12. The method according to Item 11, wherein determining (S202) the reference DRX cycle comprises determining the reference DRX cycle based on a DRX cycle for an interface between a first WD of the one or more WDs and the network node.
Item 13. The method according to Item 11 or 12, wherein the method comprises:

determining (S204) a sidelink DRX cycle, which sidelink DRX cycle is aligned with the reference DRX cycle.
Item 14. The method according to Item 13, wherein transmitting (S206) information comprises transmitting (S206A) information indicative of the determined sidelink DRX cycle.
Item 15. The method according to any one of the Items 11-14, wherein the information indicative of the sidelink DRX cycle comprises one or more of a sidelink DRX timing, a sidelink DRX rate and a time offset of the sidelink DRX cycle in relation to a timing of the reference DRX cycle.
Item 16. The method according to any one of the Items 11-15, wherein the method comprises:
   receiving (S208), from at least one WD out of the one or more WDs, a request to align a DRX cycle for an interface between the at least one WD out of the one or more WDs and the network node with the reference DRX cycle.
Item 17. The method according to Item 16, wherein the method comprises:
   determining (S210) whether a network condition satisfies an alignment criterion for moving the DRX cycle for the interface between the at least one WD out of the one or more WDs and the network node.
Item 18. The method according to Item 16 or 17, wherein the method comprises:
   upon determining that the network condition satisfies the alignment criterion for moving the DRX cycle for the interface between the at least one WD out of the one or more WDs and the network node, transmitting (S212), to the at least one WD out of the one or more WDs, a DRX configuration indicative of a DRX cycle for the interface between the at least one WD out of the one or more WDs and the network node which is aligned with the reference DRX cycle.
Item 19. The method according to any one of the Items 11-18, wherein the information indicative of the reference DRX cycle comprises one or more of a reference DRX timing, a reference DRX rate and a time offset of the reference DRX cycle in relation to a timing of a cell in which the WDs is camping.
Item 20. A wireless device comprising memory circuitry, processor circuitry, and a wireless interface, wherein the wireless device is configured to perform any of the methods according to any of Items 1-10.
Item 21. A network node comprising memory circuitry, processor circuitry, and a wireless interface, wherein the radio network node is configured to perform any of the methods according to any of Items 11-19.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

The use of the terms “first”, “second”, “third” and “fourth”, “primary”, “secondary”, “tertiary” etc. does not imply any particular order, but are included to identify individual elements.

Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the figures comprise some circuitries, components, features, or operations which are illustrated with a solid line and some circuitries, components, features, or operations which are illustrated with a dashed line. Circuitries, components, features, or operations which are comprised in a solid line are circuitries, components, features, or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. Circuitries, components, features, or operations which are comprised in a dashed line may be considered optional.

It should be appreciated that these operations need not be performed in order presented. Furthermore, it should be appreciated that not all of the operations need to be performed. The example operations may be performed in any order and in any combination. Other operations that are not described herein can be incorporated in the example operations. For example, one or more additional operations can be performed before, after, simultaneously, or between any of the described operations.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a first wireless device (WD) for handling sidelink communication with one or more second WDs residing in the same communication area for sidelink communication as the first WD, the method comprising:
receiving, from a wireless node, information indicative of a reference Discontinuous Reception (DRX), cycle determined by a network node, wherein the reference DRX cycle enables WDs residing in the communication area for sidelink communication to align their DRX cycles,
obtaining a sidelink DRX cycle which is aligned with the reference DRX cycle, and
communicating, with the one or more second WDs, in DRX occasions of the obtained sidelink DRX cycle.

2. The method according to claim 1, wherein obtaining the sidelink DRX cycle comprises receiving information indicative of the sidelink DRX cycle from the wireless node.

3. The method according to claim 1, wherein obtaining the sidelink DRX cycle comprises determining the sidelink DRX cycle based on the information indicative of the reference DRX cycle.

4. The method according to claim 3, wherein the sidelink DRX cycle is determined based on assistance information received from the one or more second WDs.

5. The method according to claim 4, wherein the assistance information is indicative of a DRX cycle of the one or more second WDs for an interface between the one or more second WD and the network node.

6. The method according to claim 1, wherein the method comprises:
transmitting, to the one or more second WDs, information indicative of the sidelink DRX cycle.

7. The method according to claim 1, wherein the method comprises:
transmitting, to the network node, a request to align a DRX cycle for an interface between the first WD and the network node with the reference DRX cycle.

8. The method according to claim 7, wherein the method comprises:
receiving, from the network node, a DRX configuration indicative of a DRX cycle for the interface between the first WD and the network node which is aligned with the reference DRX cycle.

9. The method according to claim 6, wherein the information indicative of the sidelink DRX cycle comprises one or more of a sidelink DRX timing, a sidelink DRX rate, and a time offset of the sidelink DRX cycle in relation to a timing of the reference DRX cycle.

10. The method according to claim 1, wherein the information indicative of the reference DRX cycle comprises one or more of a reference DRX timing, a reference DRX rate, and a time offset of the reference DRX cycle in relation to a timing of a cell in which the WDs is camping.

11. A method, performed by a network node, for facilitating sidelink communication between one or more wireless devices (WDs), residing in a communication area for sidelink communication, the method comprising:
determining a reference Discontinuous Reception (DRX), cycle enabling WDs residing in the communication area for sidelink communication to align their DRX cycles, and
providing, to one or more WDs residing in the communication area, information indicative of the reference DRX cycle.

12. The method according to claim 11, wherein determining the reference DRX cycle comprises determining the reference DRX cycle based on a DRX cycle for an interface between a first WD of the one or more WDs and the network node.

13. The method according to claim 11, wherein the method comprises:
determining a sidelink DRX cycle, which sidelink DRX cycle is aligned with the reference DRX cycle.

14. The method according to claim 13, wherein transmitting information comprises transmitting information indicative of the determined sidelink DRX cycle.

15. The method according to claim 11, wherein the information indicative of the sidelink DRX cycle comprises one or more of a sidelink DRX timing, a sidelink DRX rate and a time offset of the sidelink DRX cycle in relation to a timing of the reference DRX cycle.

16. The method according to claim 11, wherein the method comprises:
receiving, from at least one WD out of the one or more WDs, a request to align a DRX cycle for an interface between the at least one WD out of the one or more WDs and the network node with the reference DRX cycle.

17. The method according to claim 16, wherein the method comprises:
determining whether a network condition satisfies an alignment criterion for moving the DRX cycle for the interface between the at least one WD out of the one or more WDs and the network node.

18. The method according to claim 16, wherein the method comprises:
upon determining that the network condition satisfies the alignment criterion for moving the DRX cycle for the interface between the at least one WD out of the one or more WDs and the network node, transmitting (S212), to the at least one WD out of the one or more WDs, a DRX configuration indicative of a DRX cycle for the interface between the at least one WD out of the one or more WDs and the network node which is aligned with the reference DRX cycle.

19. The method according to claim 11, wherein the information indicative of the reference DRX cycle comprises one or more of a reference DRX timing, a reference DRX rate and a time offset of the reference DRX cycle in relation to a timing of a cell in which the WDs is camping.

20. A wireless device comprising memory circuitry, processor circuitry, and a wireless interface, wherein the wireless device is configured to perform the method according to claim 1.

21. (canceled)
